(19) United States
(12) Patent Application Publication
(10) Pub. No.: US 2008/0281006 A1
(43) Pub. Date: Nov. 13, 2008

(54) One-part non-toxic spray foam

(76) Inventors: Robert J. O;Leary, Newark, OH (US); Michelle L. Korwin-Edson, Pataskala, OH (US); Fatemeh Nassreen Olang, Granville, OH (US)

Correspondence Address: OWENS CORNING, 2790 COLUMBUS ROAD, GRANVILLE, OH, 43023, US

(21) Appl. No.: 11/801,248

(22) Filed: May 9, 2007

(51) Int. Cl. C08J 9/06

(52) U.S. Cl. 521/76

(57) ABSTRACT

A one-part spray foam formed by Michael addition chemistry is provided. The foamable composition includes at least one electron donor, at least one electron acceptor, an encapsulated catalyst, and one or more blowing agents. The catalyst is a weak or strong base. The encapsulation of the catalyst controls the polymerization of the Michael addition compounds such that the catalyst can be added and/or activated at a desired time to begin the foaming reaction. The catalyst may be encapsulated in a high molecular weight inert polymer or wax. In some embodiments, the chemical blowing agent(s) are also encapsulated. To produce a foam according to the invention, a single stream of the foamable composition is fed into an application gun where the slurry is heated and mixed. The heat and/or mixing in the gun releases the catalyst, which initiates the reaction between the Michael donor and Michael acceptor to form the foam.

### TECHNICAL FIELD AND INDUSTRIAL APPLICABILITY OF THE INVENTION

The present invention relates generally to open or closed cell foams, and more particularly, to one-part spray foams that are formed using Michael addition polymerization. BACKGROUND OF THE INVENTION

Polyurethane foams have found widespread utility in the fields of insulation and structural reinforcement. For example, polyurethane foams are commonly used to insulate or impart structural strength to items such as automobiles, hot tubs, refrigerators, boats, and building structures. In addition, polyurethane foams are used in applications such as cushioning for furniture and bedding, padding for underlying carpets, acoustic materials, textile laminates, and energy absorbing materials.

Polyurethane spray foams and their methods of manufacture are well-known. Typically, polyurethane spray foams are formed from two separate components, commonly referred to as an “A” side and a “B” side, that react when they come into contact with each other. The first component, or the “A” side, contains an isocyanate such as a di- or poly-isocyanate that has a high percent NCO. The second component, or “B” side, contains polyols that contain two or more active hydrogens, silicone-based surfactants, blowing agents, catalysts, and/or other auxiliary agents. The active hydrogen-containing compounds are typically polyols, primary and secondary polyamines, and/or water. Preferably, mixtures of diols and triols are used to achieve the desired foaming properties. The overall polyol hydroxyl number is designed to achieve a 1:1 ratio of the first component to the second component.

The first and second components are delivered through separate lines into a spray gun, such as an impingement-type spray gun. The two components are pumped through small orifices at high pressure to form streams of the individual components. The streams of the first and second components intersect and mix with each other within the gun and begin to react. The heat of the reaction causes the temperature of the reactants in the first and second components to increase. This rise in temperature causes the blowing agent located in the second component (“B” side) to vaporize and form a foam. As the mixture leaves the gun, the mixture contacts a surface, sticks to it, and continues to react until the isocyanate groups in the “A” side have completely reacted. The resulting resistance to heat transfer, or R-value, may be from about 3.5 to about 8 per inch.

Several reactions occur during the preparation of the polyurethane foam. In the primary reaction, the isocyanate and the polyol or polyamine react to form a crosslinked polymer. The progress of this reaction increases the viscosity of the mixture until a crosslinked solid is formed. In addition, the heat generated by the primary reaction vaporizes the blowing agent. As the blowing agent becomes a gas, it forms a foam. If water is present in the “B” side of the mixture, a secondary reaction between the water and the isocyanate occurs. In this reaction, the water and the isocyanate react to form carbon dioxide, which mixes with the reacting polymer to help form the foam.

One problem with such conventional polyurethane spray foams is that the first component (“A” side) contains high levels of methylene-diphenyl-di-isocyanate (MDI) monomers. When the reactants are sprayed, the MDI monomers form droplets that may be inhaled by workers installing the foam if stringent safety precautions are not followed. A brief exposure to isocyanate monomers may cause irritation to the nose, throat, and lungs, difficulty in breathing, and skin irritation and/or blistering. Extended exposure of these monomers can lead to a sensitization of the airways, which may result in an asthmatic-like reaction and possibly death.

Another problem with such conventional polyurethane spray foams is that residual polymeric methylene-diphenyl-di-isocyanate (PMDI) that is not used is considered to be a hazardous waste. Therefore, specific procedures must be followed to ensure that the waste product is properly and safely disposed of in a licensed land fill. Such precautions are costly and time consuming.

In this regard, attempts have been made to reduce or eliminate the presence of isocyanate and/or isocyanate emission by spray foams into the atmosphere. Examples of such attempts are set forth below.

U.S. Patent Publication No.2006/0047010 to O'Leary teaches a spray polyurethane foam that is formed by reacting an isocyanate prepolymer composition with an isocyanate reactive composition that is encapsulated in a long-chain, inert polymer composition. The isocyanate prepolymer composition contains an isocyanate prepolymer that contains less than about 1 wt % free isocyanate monomers, a blowing agent, and a surfactant. The isocyanate reactive composition contains a polyol or a mixture of polyols that will react with the isocyanate groups and a catalyst. During application, the spray gun heats the polymer matrix, which releases the polyols and catalyst from the encapsulating material. The polyols subsequently react with the isocyanate prepolymer to form a polyurethane foam.

EP 1 593 727 A1 to Beckley, et al. teaches a two-pack functional composition that includes a first pack having at least one multi-functional Michael acceptor, a second pack having at least one multi-functional Michael donor, and optionally, one or more non-functional ingredients or adjuvants. One or both of the first and second pack contains at least one weakly basic catalyst. To use the functional composition, the first and second packs are mixed together by any conventional mixing methods. The cured mixture may be used as an adhesive, a sealant, a coating, an elastomer, a film, or a foam.

EP 1 640 388 A2 to Kauffman discloses the use of Michael addition chemistry to form coatings, adhesives, sealants, elastomers, foams, and films. The disclosed functional mixtures include at least one multi-functional Michael acceptor, at least one multi-functional Michael donor, and at least one catalyst. The mixtures are formed from at least a two-part system in which a catalyst is present in one part that contains either the multi-functional Michael donor or the multi-functional Michael acceptor. In addition, in at least one of the multi-functional Michael donor or multi-functional Michael acceptor, the backbone is derived from bio-based feedstock. The sum of the weights of the Michael donor and/or Michael acceptor whose chemical backbone is derived from bio-based feedstock is greater than 25% by weight, based on the total weight of the functional mixture. Bio-based Michael acceptors and bio-based Michael donors include acceptors and donors derived from epoxidized soya, saccharides, castor oil, glycerol, 1,3-propanediol, propoxylated glycerol, Lesquerella oil, isossorbide, sorbitol, and mannitol.

Despite these attempts to reduce or eliminate the use of isocyanate in spray foams and/or reduce isocyanate emission into the air, there remains a need in the art for a spray foam that is non-toxic and environmentally friendly.

### SUMMARY OF THE INVENTION

It is an object of the present invention to provide a one-part reaction system for preparing a spray foam that includes at least one electron donor, at least one electron acceptor, one or more catalysts, and one or more blowing agents. The elector donor and the electron acceptor may be located on the same molecule, or, alternatively the electron donor and the acceptor may be located on separate molecules. In at least one exemplary embodiment, the electron acceptor and the electron donor are positioned on an oligomer or other single, small molecule. The catalyst, and optionally the blowing agent(s), is encapsulated in a protective, non-reactive shell that can be broken or melted at the time of the application of the foam. The protective shell surrounding the catalyst may be heat activated, shear activated, photo-activated, sonically destructed, or activated or destroyed by other methods identifiable by those of skill in the art. Examples of suitable encapsulating materials include a wax, a melamine formaldehyde polymer, acrylics, gelatin, polyethylene oxide, and polyethylene glycol. The electron donor (e.g., multi-functional Michael donor) and/or the electron acceptor (e.g., multi-functional Michael acceptor) may include an extender positioned within the polymer. In particular, the electron donor or electron acceptor functional group(s) are positioned internally on the “backbone” of the extender molecule. Non-limiting examples of extenders for use in the electron acceptors and electron donors include crop oils and epoxidized crop oils. Plasticizers such as diisononyl phthalate (DINP), diisodecyl phthalate (DIDP), and di-2-ethyl hexyl phthalate (DEHP) and/or fillers such as carbon black, calcium carbonate, clay, fly ash, and/or crop oils may be included in the foam composition to reduce manufacturing costs. Optional components such as colorants, biocides, blocking agents, solvents, tackifiers, emulsifiers, polymers, plasticizers, expandable microspheres, pigments, fillers, stabilizers, and thickeners may be included in the one-part foam composition.

It is another object of the present invention to provide a method of preparing a one-part spray foam that includes mixing at least one electron donor, at least one electron acceptor, a basic catalyst encapsulated in an encapsulating shell, and one or more blowing agents to form a one-part reaction mixture, heating the one-part reaction mixture to a temperature sufficient to activate the blowing agent, releasing the catalyst from the encapsulating shell, and permitting the electron donor and the electron acceptor to chemically react in the presence of the catalyst to form a rigid foam. The catalyst is a basic catalyst and is encapsulated in a shell that can be broken or melted at the time of the application of the foam. Optionally, the blowing agent may be encapsulated in a protective shell. The shells that at least partially surround the catalyst and blowing agent may be formed of a wax, a low melting, semi-crystalline, super-cooled polymer such as polyethylene oxide or polyethylene glycol, or a brittle polymer or acrylic that can be broken at the time of the application of the foam. It is to be noted that the encapsulant for the catalyst and the encapsulating material for the blowing agent may be the same or different. An extender such as a crop oil or epoxidized crop oil may be incorporated within the electron donor and/or electron acceptor to lower manufacturing costs. Additionally, plasticizers such as diisononyl phthalate (DINP), diisodecyl phthalate (DIDP), and/or di-2-ethyl hexyl phthalate (DEHP) and/or fillers such as carbon black, calcium carbonate, clay, fly ash, and/or crop oils may be included in the composition.

It is a further object of the present invention to provide an insulation foam product that is the reaction product of at least one multi-functional Michael donor, at least one multifunctional Michael electron acceptor, one or more catalysts, and one or more blowing agents. In at least one exemplary embodiment, the electron acceptor and the electron donor are positioned the same molecule. The electron donor and/or the electron acceptor may include an extender positioned within the polymer. Non-limiting examples of extenders for use in the multi-functional Michael acceptors and/or multi-functional Michael donors include crop oils and epoxidized crop oils. Fillers such as carbon black, calcium carbonate, clay, fly ash, and crop oils and/or plasticizers such as diisononyl phthalate (DINP), diisodecyl phthalate (DIDP), and di-2-ethyl hexyl phthalate (DEHP) may also be included in the foam composition to reduce manufacturing costs. The catalyst, and optionally the blowing agent, is encapsulated in a protective, non-reactive shell that can be broken or melted at the time of the application of the foam.

It is an advantage of the present invention that the encapsulation of the catalyst enables the catalyst to be released at the time of the application of the foam.

It is another advantage of the present invention that manufacturing costs associated with the one-part spray foam can be reduced by utilizing a filler such as a crop oil, calcium carbonate, carbon black, clay, and/or fly ash in the foamable composition.

It is a further advantage of the present invention that the foam is free of isocyanate. As a result, the foam is safe for workers to install without the need for specialized breathing equipment. Additionally, because of the lack of isocyanate in the reactive mixture, the inventive foam can be used in the house renovation market and in houses that are occupied.

It is another advantage of the present invention that the one-part spray foam has low toxicity and is easy for workers to apply.

It is also an advantage of the present invention that the one-part spray foam is not sensitive to ambient moisture. As a result, the inventive foam is less sensitive to weather conditions than a conventional polyurethane foam.

It is yet another advantage of the one-part foam composition that the one-part spray foam intrinsically meters the proper amounts of reactive products. Consequently, the flow rate of the one-part foam composition can be varied without detrimentally affecting the final foamed product.

It is a feature of the present invention that the catalyst and optionally the blowing agent(s) are encapsulated a wax, a gelatin, a low melting, semi-crystalline, super-cooled polymer such as polyethylene oxide or polyethylene glycol, or a polymer or acrylic that can be broken at the time of the application of the foam.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. The terms “one-part foam composition”, “foamable composition”, and “foam composition” may be interchangeably used in this application. In addition, the terms “encapsulant” and “encapsulating material” may be used interchangeably herein.

The present invention relates to a one-part spray foam that is formed by reacting at least one electron acceptor and at least one electron donor in the presence of a catalyst and a blowing agent. The electron donor and the electron acceptor may be located on the same molecule, or, alternatively the electron donor and acceptor may be located on different molecules. The catalyst is encapsulated in a protective, non-reactive shell that can be broken or melted at the time of the application of the foam, thus leading to a controlled polymerization of the electron donor and the electron acceptor and a controlled foaming reaction. In some embodiments, the blowing agent is also encapsulated to achieve an even more controlled foaming reaction. Extenders such as crop oils or epoxidized crop oils may be included within one or both of the electron donor and electron acceptor. To reduce the cost of the foamed product, fillers and/or plasticizers may be included in the foam composition. The foam produced may be an open or closed cell foam having an optimal R-value of 3.5 and 8 per inch, respectively.

One component in the one-part foam composition is an electron donor such as multi-functional Michael donors and molecules that include at least two active hydrogen components such as XCH—COOR (a-halo-esters) and CH-Z compounds, where Z is CHO, COR, NO₂, COOR—COOCOR, and CN, R is a linear, aliphatic, or cyclic alkyl, and X is a halogen such as chlorine, fluorine, bromine, iodine, and the like. Although any suitable electron donor or electron acceptor may be utilized in the present invention, the use of a multi-functional Michael donor and a multi-functional Michael acceptor, a preferred embodiment, will be described herein.

A Michael donor is a functional group that contains at least one active hydrogen atom, which is a hydrogen atom attached to a carbon atom that is located between two electron-withdrawing groups, such as C═O and/or C≡N. Non-limiting examples of Michael donor functional groups include malonate esters, acetoacetate esters, malonamides, and acetoacetamides (where the active hydrogen atoms are attached to the carbon atom between two carbonyl groups) and cyanoacetate esters and cyanoacetamides (where the active hydrogen atoms are attached to the carbon atom between a carbonyl group and a cyano group). On the other hand, a multi-functional Michael donor is a compound that has two or more active hydrogen atoms. In addition, a Michael donor may have one or more multiple separate functional groups that each contains one or more active hydrogen atoms. The total number of active hydrogen atoms on the molecule is the functionality of the donor. The “backbone” or “skeleton” of the Michael donor is the portion of the donor molecule other than the functional group containing the active hydrogen atom(s).

A Michael donor may have the Formula (D:

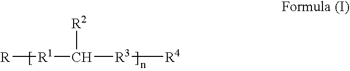

where n is 1 for mono-functional Michael donors and n is 2 or more for multi-functional Michael donors;

### R¹ is:

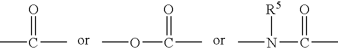

### R³ is:

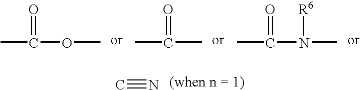

R², R⁵, and R⁶ are, independently, H, a linear, cyclic, or branched alkyl, aryl, aryalkyl, or substituted versions thereof, and R and R⁴ are residues of any of the polyhydric alcohols or polymers discussed below that are suitable as the skeleton of a multi-functional Michael donor. One or more of R², R⁵, and R⁶ may be attached to other functional groups containing active hydrogens. In addition, the one-part foam composition may contain more than one multi-functional Michael donor. In such embodiments, the mixture of multi-functional Michael donors can be designated by the number-average value of n. In some exemplary embodiments of the present invention, the mixture of multi-functional Michael donors in the composition has a number average value of n of 4 or less.

Examples of multi-functional Michael donors include, but are not limited to, acetoacetoxy substituted alkyl (meth)acrylates, amides of malonic acid, amides of acetoacetic acid, alkyl esters of malonic acid, alkyl esters of acetoacetic acid, where the alkyl groups may be linear, branched, cyclic, or a combination thereof, and alkyl compounds with two or more acetoacetate groups. Such multi-functional Michael donors include, for example, alkyl diol diacetoacetates (e.g., butane diol diacetoacetate; 1,6-hexanediol diacetoacetate; neopentylglycol diacetoacetate; the diacetoacetate of 4,8-bis(hydroxymethyl)tricyclo[5.2. 1.^{2,6}]decane; 2-methyl-1,3-propanediol diacetoacetate; ethylene glycol diacetoacetate; propylene glycol diacetoacetate; cyclohexanedimethanol diacetoacetate; other diol diacetoacetates; and alkyl triol triacetoacetates (e.g., trimethylol propane triacetoacetate, pentaerythritol triacetoacetate, glycerol trisacetoacetate, and trimethylolethane triacetoacetate).

Some additional non-limiting examples of suitable multi-functional Michael donors include tetra-, penta-, and higher acetoacetates of polyhydric alcohols (i.e., polyhydric alcohols on which four, five, or more hydroxyl groups are linked to acetoacetate groups through ester linkages), such as pentaerythritol tetraacetoacetate, dipentaerythritol pentaacetoacetate, dipentaerythritol hexaacetoacetate, and glycol ether diacetoacetates (e.g., diethylene glycol diacetoacetate, dipropylene glycol diacetoacetate, polyethylene glycol diacetoacetate, and polypropylene glycol diacetoacetate).

Other suitable multi-functional Michael donors are those that have a single Michael donor functional group per molecule and where that Michael donor functional group has two active hydrogen atoms. Examples of such multi-functional Michael donors include alkyl mono-acetoacetates (i.e., a compound whose structure is an alkyl group with a single attached acetoacetate group). Additional examples of suitable multi-functional Michael donors include compounds with one or more of the following functional groups: acetoacetate, acetoacetamide, cyanoacetate, and cyanoacetamide, in which the functional groups may be attached to one or more of the following skeletons: polyesters, polyethers, (meth)acrylic polymers, and polydienes.

The composition utilized to form the one-part foam also contains an electron acceptor such as, but not limited to, multi-functional Michael acceptors, arylalkyl ketones, and alkynes. A “Michael acceptor” is a compound that has at least one functional group having the Formula (II):

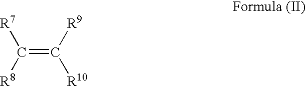

where R⁷, R⁸, and R⁹ are independently, a hydrogen or a linear, branched, or cyclic alkyl, aryl, aryl-substituted alkyl (also called aralkyl or arylkyl), alkyl-substituted aryl (also called alkaryl or alkylaryl), and derivatives and substituted versions thereof. R⁷, R⁸, and R⁹ may or may not, independently, contain ether linkages, carboxyl groups, additional carbonyl groups, thio analogs thereof, nitrogen-containing groups, and combinations thereof. R¹⁰ may be a functional group such as, but not limited to, COH, COOR, CONH₂, CN, NO₂, SOR, and SO₂R, with R being any of the groups described above for R⁷; R⁸, and R⁹. A compound with two or more functional groups, each containing Formula (II), is known herein as a multi-functional Michael acceptor. The number of functional groups containing Formula (II) on the molecule is the functionality of the Michael acceptor. The “backbone” or “skeleton” of the Michael acceptor is the portion of the acceptor molecule other than the components of Formula (II). Any compound including Formula (II) may be attached to another Formula (II) group or it may be attached directly to the skeleton.

Non-limiting examples of suitable multi-functional Michael acceptors for use in the present invention include molecules in which some or all of the structures of Formula (II) are residues of (meth)acrylic acid, (meth)acrylamide, fumaric acid, or maleic acid, and substituted versions or combinations thereof, and are attached to the multi-functional Michael acceptor molecule through either an ester linkage or an amide linkage. A compound that includes two or more residues of (meth)acrylic acid attached to the compound with an ester linkage is referred to as a “multi-functional (meth)acrylate.” Multi-functional (meth)acrylates with at least two double bonds capable of acting as the acceptor in a Michael addition reaction are suitable for use as multi-functional Michael acceptors in the present invention. Multi-functional (meth)acrylates (MFAs) suitable for use as multi-functional Michael acceptors in the one-part foam composition include multi-functional acrylates (i.e., compounds with two or more residues of acrylic acid, each attached via an ester linkage to the skeleton); alkoxylated alkyl diols; polyester oligomer diols; 2,2-bis(4-hydroxylphenyl)propane (i.e., bisphenol A); ethoxylated bisphenol A; polymers with at least two hydroxyl groups; alkyl triols; alkoxylated alkyl triols; tetra-, penta-, and higher acrylates of similar polyhydric compounds; and diacrylates of alkyl diols, glycols, and/or ether-containing diols (e.g., dimers of glycols, trimers of glycols, and polyalkylene diols).

It is to be appreciated that the skeleton of the multi-functional Michael acceptor may be the same as, or different from, the skeleton of the multi-functional Michael donor. In at least one exemplary embodiment, one or more polyhydric alcohols are used as at least one of the skeletons. Suitable examples of polyhydric alcohols for use as skeletons for either a multi-functional Michael acceptor or a multi-functional Michael donor include, but are not necessarily limited to, alkane diols, alkylene glycols, alkane diol dimers, alkane diol trimers, glycerols, pentaerythritols, polyhydric polyalkylene oxides, other polyhydric polymers, and mixtures thereof. Non-limiting specific examples of polyhydric alcohols suitable for use as skeletons of the multi-functional Michael acceptor and/or Michael donor include cyclohexane dimethanol; hexane diol; trimethylol propane; glycerol; ethylene glycol; propylene glycol; pentaerythritol; neopentyl glycol; diethylene glycol; dipropylene glycol; butanediol; 2-methyl-1,3-propanediol; trimethylolethane; 1,2-propylene glycol; 1,3-propylene glycol; 1,4-butylene glycol; 1,2-butylene glycol; 2,3-butylene glycol; 1,6-hexane diol; 1,8-octane diol; neopentyl glycol; cyclohexane dimethanol (i.e., 1,4-bis-hydroxymethyl cyclohexane); 2-methyl-1,3-propane diol; 1,2,6-hexane triol; 1,2,4-butane triol; trimethylol ethane; pentaerythritol; quinitol; mannitol; sorbitol; methyl glycoside; diethylene glycol; triethylene glycol; tetraethylene glycol; polyethylene glycol; dipropylene glycol; polypropylene glycols; dibutylene glycol; polybutylene glycols; cyclohexane dimethanol; resorcinol; and derivatives thereof. In addition, polyhydric alcohols having a molecular weight of 150 or greater may be utilized as the skeletons. One or more polyhydric alcohols in combination may be utilized to form one or both of the skeletons of the multi-functional Michael acceptor or the multi-functional Michael donor.

In some further embodiments of the present invention, the skeleton of the multi-functional Michael donor and/or the multi-functional Michael acceptor is an oligomer or a polymer. The molecular weights of the polymers may range from about 10,000 to about 1,000,000. As used herein, the term “molecular weight” is defined as weight average molecular weight. The oligomers may have molecular weights from about 300 to about 10,000. Suitable polymers for use as the skeleton(s) may have structures that are linear, branched, star shaped, looped, hyper-branched, or cross-linked. Additionally, the polymers may be homopolymers or copolymers. Non-limiting examples of suitable polymers include polyalkylene oxide, polyurethane, polyethylene, vinyl acetate, polyvinyl alcohol, polydiene, hydrogenated polydiene, alkyd, alkyd polyester, a polyolefin, a halogenated polyolefin, a polyester, a halogenated polyester, a methyacrylate polymer, and combinations thereof. The monomers forming the copolymers may be arranged randomly, in sequence, in blocks, in other known arrangements, or in any mixture or combination thereof. Suitable examples of oligomers that may be used in the skeleton(s) include tetromers and pentomers of electron donors and electron acceptors in various orders. In embodiments where the skeleton of a multi-functional Michael donor is a polymer, the Michael donor functional group may be pendant from the polymer chain and/or incorporated into the polymer chain.

As discussed above, the electron acceptor (e.g., multi-functional Michael acceptor) and electron donor (e.g., multi-functional Michael donor) may be located on the same molecule. For example, the Michael acceptor and Michael donor may be positioned on an oligomer or other single, small molecule. In such an embodiment, head-to-toe polymerization occurs between the active functional groups to form the foam. One-molecule Michael acceptor and Michael donors may have structures according to the Formula (III), where R¹, R², R³, R⁷ R⁸, R⁹ and R¹⁰ are as described above with respect to Formulas I and II, with the exception that R⁷ cannot be hydrogen.

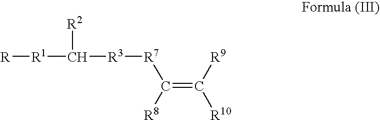

In the one-part foam composition, the mole ratio of the Michael acceptor functional groups (including multi-functional Michael acceptor functional groups) to the Michael donor functional groups (including multi-functional Michael donor functional groups) is ideally 1: 1, and would include embodiments where the electron donor and electron acceptor are on the same molecule. Although a mole ratio of the electron acceptor functional groups to the electron donor functional groups of 1:1 is preferred, this molar ratio is variable and may encompass a wider range, such as from 0.5:1 to 2:1, to maximize the reactivity of the electron acceptor and electron donor.

In order to offset the high cost of the polymers, the multi-functional Michael donor and/or the multi-functional Michael acceptor may include an extender or plasticizer positioned within the polymer. In particular, the Michael donor or Michael acceptor functional group(s) are positioned internally on the “backbone” molecule of the extender. Non-limiting examples of extenders or plasticizers for use in the Michael acceptors and Michael donors include a crop oil or epoxidized crop oil (e.g., epoxidized soy oil (ESO), linseed oil, and rapeseed oil), diisononyl phthalate (DINP), diisodecyl phthalate (DIDP), and di-2-ethyl hexyl phthalate (DEHP). In addition, fillers such as carbon black, calcium carbonate, clay, fly ash, or crop oils may be included in the one-part foam composition to reduce manufacturing costs. For example, in an extended Michael acceptor, the Michael acceptor functional group(s) is placed on the “backbone” molecule that is derived from the extender or plasticizer. A specific example of an extended Michael acceptor is depicted by Formula (IV):

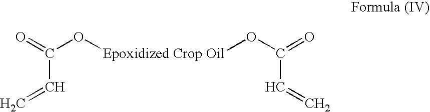

A specific example of an extended Michael donor is depicted by Formula (V):

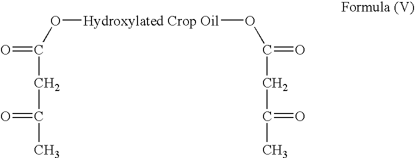

In addition, the one-part foam composition contains one or more encapsulated basic catalysts. The encapsulation of the catalyst allows the polymerization of the electron donor and the electron acceptor to start at a desired time. In preferred embodiments, the catalyst is a soluble, weak base such as, but not necessarily limited to, sodium salts of carboxylic acids, magnesium salts of carboxylic acids, aluminum salts of carboxylic acids, chromium salts of alkyl carboxylic acids having 1 to 22 carbon atoms, but preferably having 6 or less carbon atoms, chromium salts of aromatic carboxylic acids, potassium salts of alkyl mono-carboxylic acids having 1 to 22 carbon atoms, but preferably having 6 or less carbon atoms, potassium salts of multi-carboxylic acids, and combinations thereof. With respect to the invention described herein, a catalyst is a weak base if it is a basic compound where the pKa of its conjugate acid is greater than or equal to 3 and is also less than or equal to 11.

As used herein, the term “mono-carboxylic acid” is defined as a carboxylic acid that has one carboxyl group per molecule and the term “multi-carboxylic acid” is defined as a carboxylic acid that has more than one carboxyl group per molecule. The carboxylic acid utilized with respect to the catalyst includes carboxylic acids such as, but not limited to, aromatic carboxylic acids, alkyl carboxylic acids having 7 to 22 carbon atoms, alkyl carboxylic acids having 6 or fewer carboxylic acids, and combinations thereof Specific non-limiting examples of basic catalysts for use in the one-part foam composition include potassium acetate, potassium hydroxide, tetrabutylammonium hydroxide, triethylamine, sodium octoate, potassium caprylate, chromium acetate, alkoxides, tri-basic alkali metal phosphates, acetoacetonates, amidines, guanidines (e.g., tetramethyl guanidine), diaza compounds (e.g., 1,8-diazabicyclo[5.4.0]undecene and 1,5-diazabicyclo[4.3.0]nonene), alkyl amines, tetraalkyl ammonium salts, derivatives thereof, and mixtures thereof. The catalyst may be present in the one-part foam composition in an amount from about 0.01 to about 20% by weight of the total composition.

Another component of the one-part foam composition is at least one blowing agent. The blowing agent has a high miscibility and preferably acts as a plasticizer to lower the viscosity. Desirably, the blowing agent lowers the viscosity to about 100 to about 20,000 centipoise at room temperature. Blowing agents useful in the practice of this invention include inorganic blowing agents, organic blowing agents, and chemical blowing agents. Suitable inorganic blowing agents include carbon dioxide, nitrogen, argon, water, air, nitrogen, and helium. Examples of organic blowing agents which may be used in the one-part foam composition include low boiling point hydrocarbons such as cyclopentane and n-pentane, water, and inert gases such as air, nitrogen, carbon dioxide, and low boiling point hydrocarbons such as cyclopentane and n-pentane. Specific examples of suitable organic blowing agents include HFC 236ca (1,1,2,2,3,3-hexafluoropropane), HFC-236ea (1,1,1,2,3,3-hexafluoropropane), HFC-236fa (1,1,1,3,3,3-hexafluoropropane), HFC-245ca (1,1,1,2,2,3-hexafluoropropane), HFC-245ea (1,1,2,3,3-pentafluoropropane), HFC-245eb 1,1,1,2,3 pentafluoropropane), HFC-245fa (1,1,1,3,3-pentafluoropropane), HFC-356mff (1,1,1,4,4,4 -hexafluorobutane), HFC-365mfc (1,1,1,3,3-pentafluorobutane), and HCFC141b (2-fluoro 3,3-chloropropane), methyl fluoride, perfluoromethane, ethyl fluoride, 1,1-difluoroethane (HIFC-152a), 1,1,1-trifluoroethane (HFC-143a), 1,1,1,2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, and perfluorocyclobutane, methyl chloride, methylene chloride, ethyl chloride, 1,1,1-trichloroethane, 1,1 -dichloro-1-fluoroethane (HCFC-141b),1-chloro-1,1-difluoroethane (HCFC-142b), chlorodifluoromethane (HCFC-22), 1,1 -dichloro-2,2,2-trifluoroethane (HCFC-123) and 1-chloro-1,2,2,2-tetrafluoroethane (HCFC-124), trichloromonofluoromethane (CFC-11), dichlorodifluoromethane (CFC-12), trichlorotrifluoroethane (CFC-113), 1,1,1-trifluoroethane, pentafluoroethane, and dichlorotetrafluoroethane (CFC-114). Non-limiting examples of chemical blowing agents include azodicarbonamide, azodiisobutyro-nitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, siloxanes, and/or trihydrazino triazine.

HFC-245fa (1,1,1,3,3-pentafluoropropane) is particularly preferred as the blowing agent. Alternatively, a mixture of sodium bicarbonate and aluminum potassium sulfate hydrate (alum) or a mixture of sodium bicarbonate and sodium sulfate decahydrate may be used as an inexpensive blowing agent. The amount of blowing agent that may be used in the one-part foam composition is not particularly limited, but preferably falls within the range of about 2 to about 30% by weight of the total composition.

The catalyst, or combination of catalysts, and any chemical blowing agents (e.g., siloxane), the mixture of sodium bicarbonate and aluminum potassium sulfate hydrate, and the mixture of sodium bicarbonate and sodium sulfate decahydrate, if used, are encapsulated in a protective, non-reactive shell. It is to be appreciated that encapsulating the inorganic and/or organic blowing agents is considered to be within the purview of the invention. It is also within the purview of the invention to encapsulate the catalyst and blowing agent in a single, encapsulating shell. The material encapsulating the blowing agent(s) may be the same as or different from the encapsulating material utilized for the catalyst. Encapsulating the blowing agent permits an accurate release of the blowing agent at a desired time.

The catalyst and the blowing agents may be separately encapsulated in a wax or gelatin that can be melted at the time of the application of the foam. Desirably, the wax has a melting point from about 120° F. to about 180° F., and more preferably has a melting point from about 143° F. to about 153° F. Alternatively, the encapsulating shell may be formed of a brittle polymer (such as a melamine formaldehyde polymer) or an acrylic that can be broken at the time of the application of the foam to initiate the polymerization of the electron donor(s) and electron acceptor(s). The protective shells surrounding the catalyst and the blowing agent may be heat activated, shear activated, photo-activated, sonically destructed, or activated or destroyed by other methods known to those of skill in the art.

Optionally, the encapsulating material may be a low melting, semi-crystalline, super-cooled polymer. Non-limiting examples of low melting polymers include polyethylene oxide (PEO) and polyethylene glycol (PEG). A preferred low-melting polymer for use as an encapsulant is a polyethylene oxide that has a molecular weight from about 100,000 to about 8,000,000. Additionally, the glass transition temperature (Tg) of the super-cooled polymer may be adjusted to the application temperature of the reaction system by blending polymers. For example, polymer blends such as a blend of potyvinylchloride (PVC) and polyethylene oxide (PEO) may be used to “fine tune” the glass transition temperature and achieve a desired temperature at which the polymer melts or re-crystallizes to release the catalyst. With a PVC/PEO blend, the desired glass transition temperature is a temperature between the Tg of polyvinyl chloride and the Tg of the polyethylene oxide and is determined by the ratio of PVC to PEO in the polymer blend. When the super-cooled polymer is heated above its glass transition temperature, such as in a spray gun, the polymer re-crystallizes and the catalyst (or blowing agent) is expelled from the polymer. This expulsion of the catalyst (or blowing agent) is due to the change in free volume that occurs after re-crystallization of the polymer.

Further, the one-part foam composition may optionally contain one or more surfactants to impart stability to foaming process, to provide a high surface activity for the nucleation and stabilization of the foam cells, and to obtain a finely distributed, uniform foam. In addition, the surfactant permits the reacting components (e.g., the multi-functional Michael acceptor and the multi-functional Michael donor) and the gaseous blowing agent to form a stable emulsion. Suitable surfactants for use in the one-part foam composition include DABCO® 197, DABCO® DC 5098, DABCO® 193, and DABCO® 120, all of which are silicone glycol copolymers commercially available from Air Products, polydimethylsiloxanes having a relatively low viscosity, and silicones such as, but not necessarily limited to, polyalkylsiloxane-polyoxalkylene copolymers. The surfactant may be present in the one-part foam composition in an amount from about 0.1 to about 3% by weight of the total composition.

Flame retardants may also be added to the foamable composition to render the foam flame retardant. Suitable flame retardants include tris(chloroethyl)phosphate, tris(2-chloroethyl)phosphate, tris(dichloropropyl)phosphate, chlorinated paraffins, tris(chloropropyl)phosphate, phosphorus-containing polyols, and brominated aromatic compounds such as pentabromodiphenyl oxide and brominated polyols. The flame retardant is preferably present in the one-part foam composition in an amount from about 0.1 to about 5% by weight of the total composition.

Other additives such as colorants (e.g., diazo or benzimidazolone family of organic dyes), biocides, blocking agents, solvents, tackifiers, emulsifiers, polymers, plasticizers, expandable microspheres, pigments, stabilizers, and thickeners may be present in the one-part foam composition. The additives are desirably chosen and used in a way such that the additives do not interfere with the mixing of the ingredients, the cure of the reactive mixture, the foaming of the composition, or the final properties of the foam. In addition, by manipulating the ratios of Michael donors to Michael acceptors, reactant functionalities, catalysts, amount of catalysts, and the additives included, one of ordinary skill in the art can prepare a rigid foam according to the present invention that possesses desired properties.

To create a foam according to at least one exemplary embodiment of the present invention, the multi-functional Michael donor, the multi-functional Michael acceptor, the encapsulated catalyst, the blowing agent, and any optional components are mixed to form a slurry (reaction mixture). It is to be noted that there is no reaction between the Michael donor and the Michael acceptor in the slurry due to the encapsulation of the catalyst. As a result, the foamable reactive composition is stable for extended periods of time. The mole ratio of the total of all the functional groups in the Michael acceptors in the composition to total of all the functional groups in the Michael donors in the reactive composition may range from 0.5:1-2:1.

A single stream of the slurry containing the multi-functional Michael donor, the multi-functional Michael acceptor, the encapsulated catalyst, and the blowing agent may then be fed into an application gun, such as a spray gun, that has the ability to mix and/or heat the slurry within the gun. The slurry is heated within the gun to a temperature above the melting point of the long chain polymer or wax containing the catalyst and optionally the polymer or wax encapsulating the blowing agent so that the catalyst, and blowing agent (if encapsulated) are released from the polymer or wax. In addition, the mixing action within the gun may assist in the release of the catalyst and/or blowing agent from the encapsulant. It is to be appreciated that in alternate embodiments, the encapsulating shell of the catalyst and/or blowing agent may be shear activated, sonically activated, or photo activated. In preferred embodiments, the slurry is heated to a temperature of about 140° F. to about 180° F. Once the catalyst is released from the polymer shell, polymerization of the Michael donor and the Michael acceptor begins and heat is generated.

The heat of the reaction (and also the heat of the gun) causes the temperature of the reactants to increase. Once the temperature of the blowing agent reaches its boiling point, the blowing agent vaporizes and creates a foamed product. The reacting mixture is sprayed from the gun to a desired location where the mixture continues to react and form either open or closed cell foams. The foam may have an R-value from about 3.5 to about 8 per inch. The foam is advantageously used in residential housing, commercial buildings, appliances (e.g., refrigerators and ovens), and hot tubs.

One advantage of the one-part spray foam according to the invention is that by encapsulating the catalyst, the catalyst can be released at the time of the application of the foam, leading to a controlled polymerization of the Michael polymers and subsequent foaming. Similarly, encapsulating the blowing agent further controls when the foaming occurs because the foam cannot be formed until the blowing agent is released from the encapsulating, protective shell.

It is another advantage of the present invention that no isocyanates are present in the one-part foamable compositions, and, as a result, no isocyanate monomers are emitted during the foam's formation. As a result, the inventive one-part foam reduces the threat of harm to individuals working with or located near the foam.

Additionally, the inventive foam can advantageously be used in the renovation market and in houses that are occupied. Existing, conventional two-part foams should not be used in these applications because of the generation of high amounts of free isocyanate monomers that could adversely affect the occupants of the dwelling. Exposure of isocyanate monomers may cause irritation to the nose, throat, and lungs, difficulty in breathing, skin irritation and/or blistering, and a sensitization of the airways. Because the inventive one-part foam does not contain any isocyanates, there can be no isocyanate monomers emitted into the air.

Other advantages of the one-part non-toxic foam include simplicity and potential economic advantages. For example, a proportioning pump delivers a predetermined, precise ratio of isocyanate to polyol to a spray gun. The isocyanate mixture is injected into one orifice of the chamber of the spray gun and the polyol mixture is injected into a second orifice of the chamber of the spray gun. Inside the chamber of the spray gun, the isocyanate and polyol mix to form an isocyanate-based spray foam.

Existing two-part, conventional isocyanate foams require several pumps to transport the isocyanate reactive material from the storage to the spray gun. In conventional isocyanate foams, problems can arise at any point along the processing line. For instance, the isocyanate mixture in the storage drums may form a gel in the presence of ambient moisture, which can clog the pumps and/or the spray gun. The clogging of even one of the pumps can result in an uneven distribution of the reactive components, which results in a poor foam product. In addition, if the temperature surrounding the drum containing the polyol mixture rises, the mixture may overheat and cause blowing agent cavitations in the first pump and also starve the proportioning pump of an adequate polyol mixture. Additionally, viscosity differences between the isocyanate and the polyol can result in poor mixing within the gun, thereby resulting in an inadequate foam.

On the other hand, the one-part inventive spray foam requires only a single pump, thereby eliminating the problems associated with a multiple pump system such as is described above. Because the one-part foam composition intrinsically meters the proper amounts of the reactive products, the flow rate of the single stream composing the one-part foam composition can be varied without detrimentally affecting the final foamed product. Additionally, the one-part foam composition does not require intense mixing within the gun. As a result, a simple spray gun having only one orifice may be utilized to spray the foam composition. Without a sophisticated pumping system and complex spray gun, producing the inventive one-part foam has a low manufacturing cost. In addition, the one-part foamable composition is simpler to use in the field than conventional two-part foams. Therefore, less training is required to correctly use the one-part foam composition.

In addition, the one-part spray foam is not sensitive to ambient moisture. As a result, the inventive foam is less sensitive to weather conditions than a conventional polyurethane foam. Further, if the electron acceptor and the electron donor are positioned on the same molecule, the consumer needs to purchase only one reactive material to form the foam, thereby reducing costs.

Having generally described this invention, a further understanding can be obtained by reference to certain specific examples illustrated below which are provided for purposes of illustration only and are not intended to be all inclusive or limiting unless otherwise specified.

### EXAMPLE

Table 1 sets forth a list of proposed components that may be used to make at least one example of the inventive foam.

TABLE 1

| Trade Name | Description | Manufacturer |
|---|---|---|
| Acceptors | | |
| Morecure 2000 | Diacrylate of diglycidyl ether of | Rohm and |
| | bisphenol-A | Haas |
| SR-259 | Polyethylene glycol (200) diacrylate | Sartomer |
| SR-610 | Polyethylene glycol (600) diacrylate | Sartomer |
| EB-860 | Epoxidized Soya acrylate | UCB Surface |
| | | Specialties |
| Donors | | |
| TMP Tris | Trimethylol propane triacetoacetate | Aldrich |
| Acetoacetate | | |
| NPG Bis | Neopentyl glycol bisacetoacetate | Aldrich |
| Acetoacetate | | |
| Blowing Agents | | |
| HFC-245fa | 1,1,1,3,3-pentafluoropropane | Honeywell |
| Encapsulated | Sodium bicarbonate/aluminum sulfate | |
| Bicarbonate | hydrate encapsulated in wax | |
| Surfactants | | |
| Dabco ® 193 | Polysiloxane surfactant | Air Products |
| Dabco ® DC | Non-hydrolyzable silicone surfactant | Air Products |
| 5098 | | |
| Dabco ® DC 197 | Silicone glycol copolymer surfactant | Air Products |
| Catalyst | Potassium Acetate | Aldrich |
| | Tetramethyl guanidine | Aldrich |
| Encapsulants | | |
| UCARFLOC 300 | Polyethylene oxide 4,000,000 mw | Dow Chemical |
| | Paraffin Wax | |

Prophetic examples of forming the encapsulated catalyst and the reactive mixture using components identified in Table 1 are set forth in Tables 2, 3, and 4.

TABLE 2
Encapsulated Catalyst

| | Catalyst 1 | Catalyst 2 |
|---|---|---|
| Component | (grams) | (grams) |
| Potassium Acetate | 20 | |
| Tetramethyl guanidine | | 30 |
| UCARFLOC 300 | 100 | 100 |

TABLE 3
Encapsulated Blowing Agent

| | Blowing |
|---|---|
| | Agent 1 |
| Component | (grams) |
| Paraffin wax | 50 |
| Sodium Bicarbonate | 50 |
| Aluminum Sulfate hydrate | 50 |

TABLE 4
Examples of Electron Donor/Acceptor Mixtures

| | Electron | Electron |
|---|---|---|
| | Acceptor/Donor | Acceptor/Donor |
| | Mixture 1 | Mixture 2 |
| Component | (grams) | (grams) |
| Morecure 2000 | 10.2 | |
| SR-259 | 4.8 | 14.8 |
| NPG Bis Acetoacetate | | 20 |
| TMP Tris Acetoacetate | 16.2 | |
| Catalyst 1 (Table 3) | 1.19 | |
| Catalyst 2 (Table 3) | | 7.58 |
| DABCO ® 193 | 0.095 | |
| DABCO ® 197 | | 0.11 |
| Blowing Agent 1 (Table 4) | | 10.95 |
| HFC 245fa | 6.28 | |

In the “Catalyst 1” example set forth above in Table 2, potassium acetate is mixed with a molten UCARFOC 300 polymer. The mixture is poured onto a disk spinning at approximately 10,000 RPM by a technique known to those of ordinary skill in the art of encapsulation. Tiny droplets of polymer are ejected at the edge of the disk and cooled in a stream of air. The droplets cool very quickly, and, as a result, a super-cooled polymer is formed.

In the “Catalyst 2” example set forth above in Table 2, the same procedure is followed as with the “Catalyst I” example, except that tetramethyl guanidine is utilized as the catalyst to form the super-cooled polymer.

In the “Blowing Agent 1” example set forth in Table 3, the sodium bicarbonate and aluminum sulfate hydrate are mixed into a molten paraffin wax to form an encapsulated blowing agent.

In the electron donor/acceptor examples set forth in Table 4, the components are mixed together in a vessel until uniform. No reaction between the electron donor and electron acceptor occurs. This mixture forms a portion of the foamable composition.

To form a foam, the components in Table 5 are mixed together with an encapsulated blowing agent and encapsulated catalyst. The mixture is pumped through a hose to an application gun. It is envisioned that the gun will be equipped with a heating mechanism that will heat the mixture to a temperature that is sufficient (1) to melt or otherwise destroy the encapsulating materials of the blowing agent and catalyst and (2) activate the catalyst and create a foam.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A one-part reaction system for preparing a spray foam comprising:
at least one electron donor;
at least one electron acceptor;
a basic catalyst encapsulated in a non-reactive shell; and
one or more blowing agents.

2. The one-part reaction system of claim 1, wherein said at least one electron donor is selected from multi-functional Michael donors and molecules including at least two active hydrogen components, said active hydrogen components being selected from a-halo-esters, CH—CHO, CH—COR, CH—COOR—COOCOR and CH—CN where R is a linear, aliphatic, or cyclic alkyl; and
wherein said at least one electron acceptor is selected from multi-functional Michael acceptors, arylalkyl ketones and alkynes.

3. The one-part reaction system of claim 1, wherein said at least one electron donor and said at least one electron acceptor are located in one molecule.

4. The one-part reaction system of claim 1, wherein said non-reactive shell is destroyed by a member selected from heat activation, shearing, photo activation and sonic activation to release said catalyst.

5. The one-part reaction system of claim 1, wherein said catalyst is encapsulated by an encapsulating material selected from a wax, a melamine formaldehyde polymer, an acrylic, a gelatin, polyethylene oxide, polyethylene glycol and combinations thereof.

6. The one-part reaction system of claim 1, wherein said one or more blowing agents is encapsulated by an encapsulating material selected from a wax, a melamine formaldehyde polymer, an acrylic, a gelatin, polyethylene oxide, polyethylene glycol and combinations thereof.

7. The one-part reaction system of claim 1, wherein said basic catalyst and said one or more blowing agents are encapsulated in a single, non-reactive shell.

8. The one-part reaction system of claim 1, wherein said at least one of said electron donor and said electron acceptor includes an extender compound.

9. The one-part reaction system of claim 8, wherein said extender compound is selected from crop oils and epoxidized crop oils.

10. A method of preparing a one-part spray foam comprising:
mixing at least one electron donor, at least one electron acceptor, a basic catalyst encapsulated in an encapsulating shell, and one or more blowing agents to form a one-part reaction mixture;
heating said one-part reaction mixture to a temperature sufficient to activate said blowing agent;
releasing said catalyst from said encapsulating shell; and
permitting said electron donor and said electron acceptor to chemically react in the presence of said catalyst to form a rigid foam.

11. The method of claim 10, wherein said catalyst is released from said encapsulating shell by a member selected from heat activation, shearing, photo activation and sonic activation.

12. The method of claim 10, wherein said encapsulating shell is an encapsulant selected from a wax, a melamine formaldehyde polymer, acrylic, a gelatin, polyethylene oxide, polyethylene glycol and combinations thereof.

13. The method of claim 10, further comprising:
encapsulating said blowing agent in an encapsulant selected from a wax, a melamine formaldehyde polymer, acrylic, gelatin, polyethylene oxide, polyethylene glycol and combinations thereof prior to forming said one-part reaction mixture.

14. The method of claim 13, wherein said heating step releases said blowing agent from said encapsulant.

15. The method of claim 10, further comprising:
adding an extender molecule to at least one of said electron acceptor and said electron donor.

16. An insulation foam product comprising the reaction product of:
at least one multi-functional Michael donor;
at least one multi-functional Michael acceptor;
a basic catalyst encapsulated in a non-reactive shell; and
one or more blowing agents.

17. The insulation foam product of claim 16, wherein said multi-functional Michael donor and said at least one Michael acceptor are positioned on the same molecule.

18. The insulation foam product of claim 17, wherein said basic catalyst and said one or more blowing agents are encapsulated in a single, non-reactive shell.

19. The insulation foam product of claim 16, wherein said at least one of said multi-functional Michael donor and said multi-functional Michael acceptor includes an extender compound selected from crop oils and epoxidized crop oils.

20. The insulation foam product of claim 17, wherein said one or more blowing agents is encapsulated in an encapsulating material selected from a wax, a melamine formaldehyde polymer, acrylic, a gelatin, polyethylene oxide, polyethylene glycol and combinations thereof.
